(19) United States
(12) Patent Application Publication
(10) Pub. No.: US 2021/0403279 A1
(43) Pub. Date: Dec. 30, 2021

(54) METHOD AND DEVICE FOR INSTALLING ELEVATOR DOOR COMPONENTS

(71) Applicant: OTIS ELEVATOR COMPANY, Farmington, CT (US)

(72) Inventors: Joseph Crute, Cromwell, CT (US); Tadeusz Pawel Witczak, Farmington, CT (US); Michael J. Tracey, Cromwell, CT (US); James Chmiel, Suffield, CT (US)

(21) Appl. No.: 16/914,455

(22) Filed: Jun. 28, 2020

(51) Int. Cl. B66B 1/34; B66B 13/14; B66B 3/02

(52) U.S. Cl. CPC B66B 1/3492; B66B 5/0018; B66B 3/02; B66B 13/143

(57) ABSTRACT

An illustrative example embodiment of a device that facilitates installing at least one elevator door component, includes a detector that is configured to detect at least one reference feature in a vicinity of a desired position of the elevator door component. A processor is configured to use information from the detector to determine the desired position of the elevator door component relative to the at least one detected feature. An indicator is configured to provide at least one indication corresponding to the desired position of the elevator door component.

### BACKGROUND

Elevator systems include doors at each entry to the hoistway. The landing or hoistway doors face toward the hallway or lobby from which a passenger enters the elevator car. The elevator car doors are supported on the elevator car. The landing doors remain at the respective installed locations while the elevator car doors travel with the elevator car along the hoistway.

It is necessary to accurately install the hoistway door components, such as the sill, and door header to achieve the precise alignment needed between the elevator car and the sill. Many hoistways are built in a way that makes aligning all hoistway door sills along the hoistway challenging and time-consuming. Even skilled installers have to make multiple measurements and adjustments to get everything properly aligned.

### SUMMARY

An illustrative example embodiment of a device that facilitates installing at least one elevator door component, includes a detector that is configured to detect at least one reference feature in a vicinity of a desired position of the elevator door component. A processor is configured to use information from the detector to determine the desired position of the elevator door component relative to the at least one detected feature. An indicator is configured to provide at least one indication corresponding to the desired position of the elevator door component.

In an example embodiment having at least one feature of the device of the previous paragraph, the at least one indication comprises a visual indication.

In an example embodiment having at least one feature of the device of any of the previous paragraphs, the indicator comprises a laser and the at least one visual indication is a laser projected image.

In an example embodiment having at least one feature of the device of any of the previous paragraphs, the visual indication is situated to appear on a portion of the elevator door component to visually indicate when the elevator door component is in the desired position.

In an example embodiment having at least one feature of the device of any of the previous paragraphs, the visual indication is situated to appear on a surface near the desired position of the elevator door component.

In an example embodiment having at least one feature of the device of any of the previous paragraphs, the detector comprises a LiDAR detector.

In an example embodiment having at least one feature of the device of any of the previous paragraphs, the detector is configured to use photogrammetry to detect at least one feature of a hoistway in a vicinity of the desired position of the elevator door component within an image and the processor is configured to use information regarding the detected at least one feature within the image and provided information regarding a relationship between the detected at least one feature and the desired position to determine the desired position.

In an example embodiment having at least one feature of the device of any of the previous paragraphs, the detector is configured to detect at least one target that is placed in a known location relative to the desired position of the elevator door component.

In an example embodiment having at least one feature of the device of any of the previous paragraphs, the detector is configured to detect at least one marker on the elevator door component, the processor is configured to determine a current position of the elevator door component relative to the desired position based on information from the detector regarding a position of the at least one marker on the elevator door component, the processor is configured to determine a change in position of the elevator door component to bring the elevator door component into the desired position, and the processor is configured to control the indicator to dynamically change the indication based on variations in the determined change in position.

In an example embodiment having at least one feature of the device of any of the previous paragraphs, the at least one indication comprises an audible indication.

An illustrative example embodiment of a method of facilitating installation of at least one elevator door component includes detecting at least one reference feature in a vicinity of a desired position of the elevator door component, using at least one processor for automatically determining the desired position of the elevator door component relative to the at least one detected feature, and providing at least one indication corresponding to the desired position of the elevator door component.

In an example embodiment having at least one feature of the method of the previous paragraph, the at least one indication comprises a visual indication.

An example embodiment having at least one feature of the method of any of the previous paragraphs includes using a laser to provide the at least one visual indication as a laser projected image.

An example embodiment having at least one feature of the method of any of the previous paragraphs includes causing the visual indication to appear on a portion of the elevator door component to visually indicate when the elevator door component is in the desired position.

An example embodiment having at least one feature of the method of any of the previous paragraphs includes causing the visual indication to appear on a surface near the desired position of the elevator door component.

In an example embodiment having at least one feature of the method of any of the previous paragraphs, the detecting is performed using a LiDAR detector.

In an example embodiment having at least one feature of the method of any of the previous paragraphs, the detecting is performed using photogrammetry to detect at least one feature of a hoistway in a vicinity of the desired position of the elevator door component within an image and determining the desired position of the elevator door component comprises using information regarding the detected at least one feature within the image and provided information regarding a relationship between the detected at least one feature and the desired position.

In an example embodiment having at least one feature of the method of any of the previous paragraphs, the detecting comprises detecting at least one target that is placed in a known location relative to the desired position of the elevator door component.

In an example embodiment having at least one feature of the method of any of the previous paragraphs, the detecting comprising detecting at least one marker on the elevator door component. Automatically determining the desired position comprises using the processor to determine a current position of the elevator door component relative to the desired position based on information regarding a position of the at least one marker on the elevator door component and using the processor to determine a change in position of the elevator door component to bring the elevator door component into the desired position and providing the at least one indication comprises dynamically changing the indication based on variations in the determined change in position.

In an example embodiment having at least one feature of the method of any of the previous paragraphs, providing the at least one indication comprises providing an audible indication.

The various features and advantages of at least one example embodiment will become apparent to those skilled in the art from the following detailed description. The drawings that accompany the detailed description can be briefly described as follows.

### BRIEF DESCRIPTION OF THE DRAWINGS

FIG. 1 is a side elevation view of elevator door components installed according to an embodiment consistent with this description.

FIG. 2 schematically illustrates a portion of an example installation process according to an embodiment consistent with this description.

FIG. 3 schematically illustrates another portion of the example installation process.

FIG. 4 schematically illustrates another portion of the example installation process.

FIG. 5 diagrammatically illustrates an example device that facilitates elevator door component installation according to an embodiment consistent with this description.

FIG. 6 diagrammatically illustrates another example device that facilitates elevator door component installation according to an embodiment consistent with this description.

### DETAILED DESCRIPTION

Embodiments of a device or method consistent with the teachings of this description facilitate installing elevator door components, such as a hoistway door sill, in an efficient and accurate manner

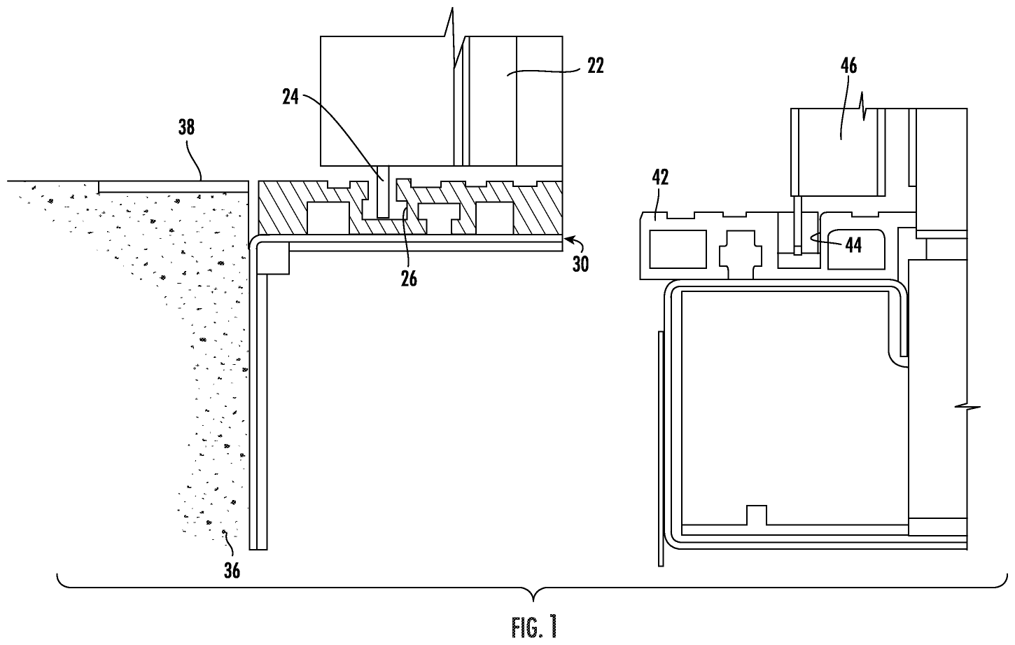

FIG. 1 illustrates selected portions of an elevator door assembly 20. A hoistway door 22 includes a guide 24 that follows a track 26 as the hoistway door 22 moves between open and closed positions. The track 26 is part of a sill 30 that also includes mounting pieces 32 and 34. The sill 30 is secured to a structure, such as a hoistway wall 36 near a floor 38 at the corresponding landing.

Positioning the sill 30 is important to achieve a desired spatial relationship and alignment with an elevator car door sill 42, which includes a track 44 that guides movement of the elevator car door 46.

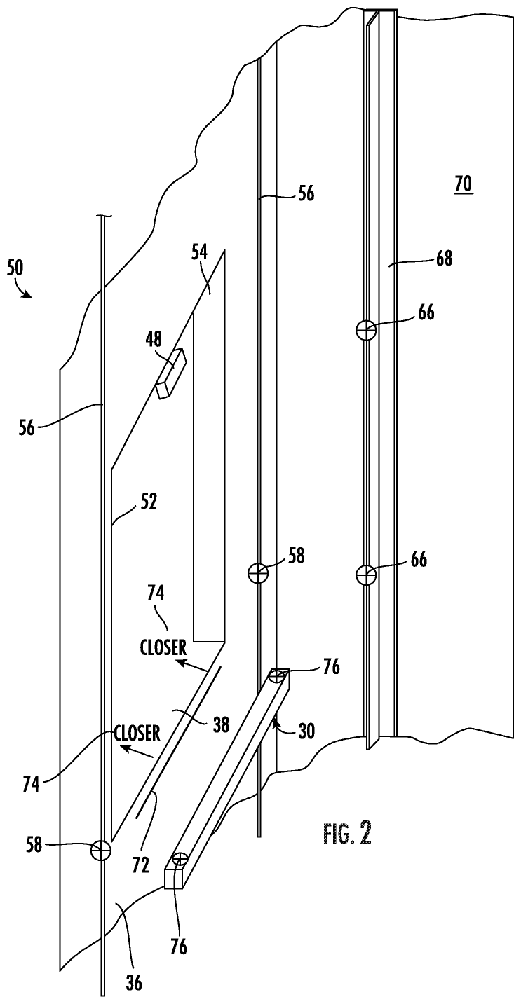

As shown in FIG. 2, a device 48 facilitates installing elevator door components, such as the sill 30, in a hoistway 50. Only portions of the hoistway 50 near an opening 52 are shown for discussion purposes. The device 48 is temporarily mounted to a portion of the hoistway opening 52 in the illustrated example scenario. The opening 52 is a feature in the hoistway wall 36 that is bordered by sides 54 and the floor 38 and allows access to the hoistway 50 for the door frame structure that eventually defines the opening into the hoistway. The sill 30 will be installed near the landing floor 38 by being secured to the hoistway wall 36 at the floor level 38 in this example scenario.

Plumb lines 56 are situated in the hoistway 50 to provide vertical references that may be used for various purposes during installation of the elevator system. In this embodiment, targets 58 are at least temporarily secured to the plumb lines 56. The targets 58 are detectable by a sensor or detector portion of the device 48. Additional targets 66 are supported on a guide rail 66 that is supported along another hoistway wall 70. Any or all of the targets 58, 66 provide reference locations within the hoistway in the vicinity of the opening 52. Those reference locations allow the device 48 to determine a desired position of the sill 30.

The sensor or detector portion of the device 48 in some embodiments includes a LiDAR (light distance and ranging) sensor that detects one or more of the targets 58, 66 or features of the hoistway 50. Information from the LiDAR sensor is processed by the processor portion of the device 48 to determine distance information based on the locations of the hoistway features or targets 58, 66. The distance information may be based on, for example, known relationships between the positions of the targets and an intended position of a door component, such as the sill 30.

In some embodiments, the device 48 has photogrammetry capability that uses known pixel density analysis to determine distances associated with at least one of the targets 58, 66 or at least one feature of the hoistway 50 to determine the position of the sill 30. For example, one example device 48 obtains image information based on a camera, scanner or sensor capturing at least one image of a portion of the hoistway near the opening 52 where the sill 30 will be installed. A user provides a measured or known distance between the physical features or items in the hoistway 50 that also appear in the image through a user interface that communicates with a processor or computing device of the device 48. The processor then determines a spatial relationship between the location(s) of the detected target(s) or features of the hoistway 50 and determines the desired position of the sill 30 relative to the image information.

The device 48 provides at least one visual indication 72 that informs an installer of the proper position of the sill 30. For example, the visual indication 72 is a line that establishes at least a horizontal alignment of the sill 30 relative to the edge of the floor 38. In the illustrated example embodiment, additional visual indications 74 provide information regarding necessary movement of the sill 30 to achieve proper positioning of the sill 30.

The visual indications 72 and 74 are projected by a laser projector of the device 48 in the illustrated example embodiment. The visual indications 74 may be provided on the floor 38 as shown or in another location that would be convenient for an installer. The visual indication 72 may only be visible on the sill 30 when the sill is sufficiently close to the intended installed position.

In this embodiment, markers 76 are provided on the sill 30 at least during the installation process. The device 48 detects or senses the markers 76 in a manner similar to recognizing the targets 58, 62, 66. The device 48 in this embodiment dynamically updates the visual indications 74 to guide the installer while positioning the sill 30 based on the locations or movement of the markers 76. The processor or computing device of the device 48 uses suitable programming or is otherwise configured to provide appropriate visual indications 74. Those skilled in the art who have the benefit of this description will realize how to use commercially available technology to provide visual indications that meet the needs of their particular situation.

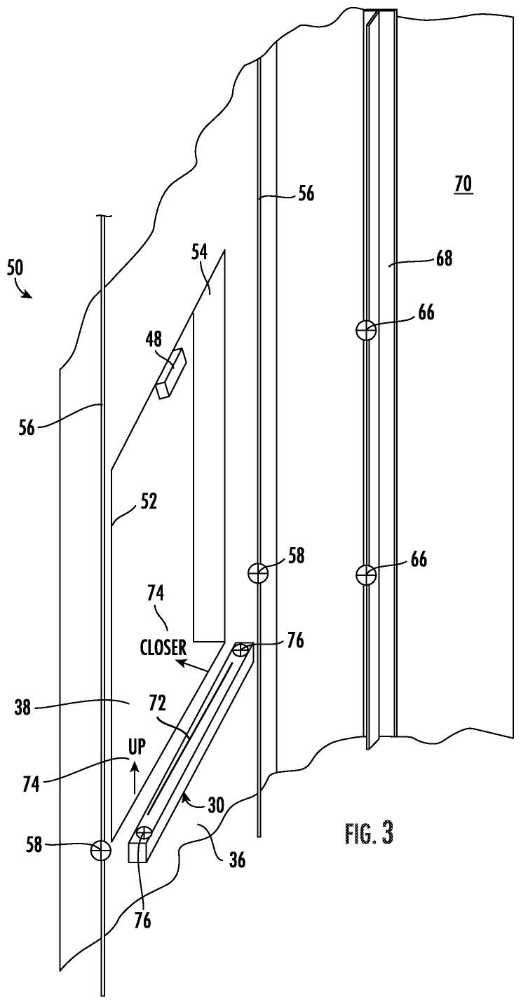

In FIG. 2, the sill 30 needs to be brought closer to the edge of the floor 38 along the bottom of the opening 52. FIG. 3 shows the sill 30 closer to the desired position. In FIG. 3, the sill 30 is not yet properly aligned. The visual indicator 72 shows a desired alignment or position of a feature of the sill 30 that indicates when the sill 30 is properly aligned in a horizontal direction relative to the edge of the floor 38 or the hoistway wall 36. In FIG. 3, the sill 30 is not yet properly aligned. One of the visual indicators 74 prompts the installer to move the corresponding side or end of the sill 30 closer to the hoistway wall 36. The other visual indicator 74 prompts the installer to raise the other end of the sill 30 relative to the floor 38 to properly level the sill 30.

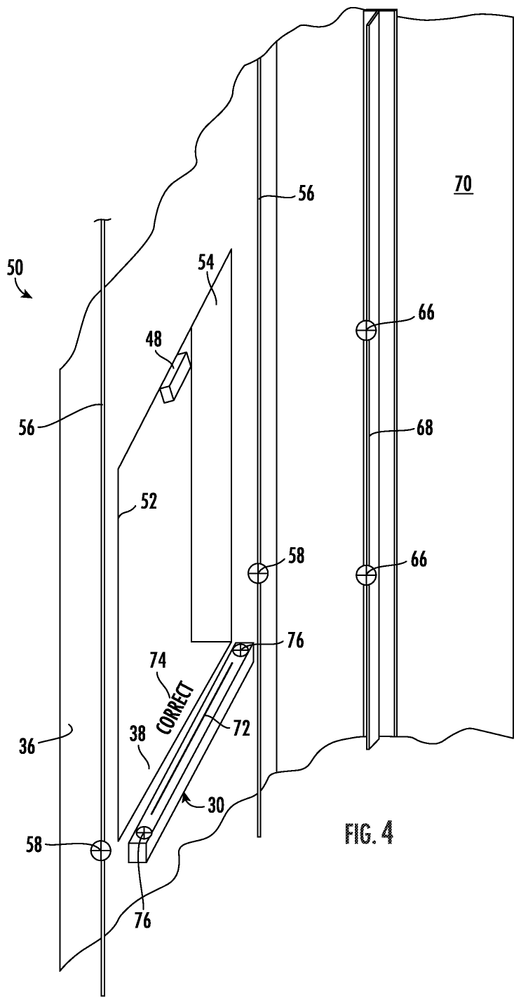

FIG. 4 shows the sill 30 in the desired position where the visual indication 72 is aligned with a feature of the sill 30 and the visual indicator 74 confirms for the installer that all aspects of the position of the sill 30 are correct. In this position, the installer can secure the sill 30 in place. The visual indications 72, 74 provided by the device 48 guide the installer during the process of positioning and securing the sill 30 in place. The device 48 saves significant time and reduces the complexity of the installation process. The installer no longer needs to make multiple distance measurements and verify the level of the sill 30 in multiple directions (e.g., parallel to the threshold of the opening 52 and into the hoistway 50). Additionally, the device 48 provides confirmation that the sill 30 is properly installed, which reduces the likelihood that subsequent adjustment will be needed.

One feature of the device 48 is that it can provide visual indications guiding the installer where to drill holes in the hoistway wall 36 for mounting the sill prior to bringing the sill 30 into or near the desired position. The task of locating the proper drill locations is typically challenging and time-consuming in and of itself.

While the sill 30 is used as an example door component in FIGS. 2-4 and the preceding description, other door components can be installed with the aid or direction provided by the device 48. Additionally, while visual indications 72, 74 are illustrated, some embodiments provide audible indications to guide the installer while positioning and installing the sill 30 or other door component.

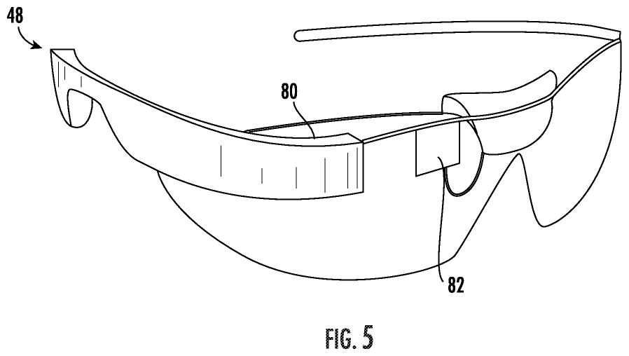

FIG. 5 illustrates another embodiment of a device 48 that facilitates installing an elevator door component, such as the sill 30. In this embodiment, the device 48 comprises augmented reality glasses. A detector or scanner 80 locates any targets or features of the hoistway and a projector 82 causes a display of the visual indications 72, 74 to appear in an augmented reality view of the corresponding portion of the hoistway near the opening 52.

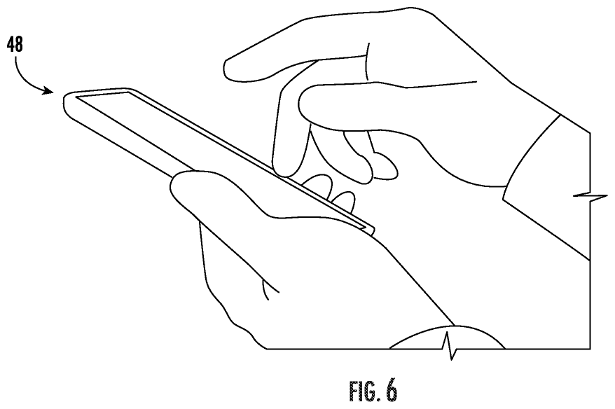

FIG. 6 shows another embodiment of the device 48. In this example embodiment, the device 48 includes a smart phone or a dedicated, hand-held device that an installer can carry. The device 48 of FIG. 6 uses photogrammetry or another type of reference scan of the corresponding portion of the hoistway, for example, and determines the desired position of the sill or other door component based on the gathered image information. Such devices 48 may provide projected visual indications like the indications 72 and 74 or may present an augmented reality display on the device 48 that the installer can use as a guide during the installation process consistent with the description provided above.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A device that facilitates installing at least one elevator door component, the device comprising:
a detector that is configured to detect at least one reference feature in a vicinity of a desired position of the elevator door component;
a processor that is configured to use information from the detector to determine the desired position of the elevator door component relative to the at least one detected feature; and
an indicator that is configured to provide at least one indication corresponding to the desired position of the elevator door component.

2. The device of claim 1, wherein the at least one indication comprises a visual indication.

3. The device of claim 2, wherein
the indicator comprises a laser, and
the at least one visual indication is a laser projected image.

4. The device of claim 2, wherein the visual indication is situated to appear on a portion of the elevator door component to visually indicate when the elevator door component is in the desired position.

5. The device of claim 2, wherein the visual indication is situated to appear on a surface near the desired position of the elevator door component.

6. The device of claim 1, wherein the detector comprises a LiDAR detector.

7. The device of claim 1, wherein
the detector is configured to use photogrammetry to detect at least one feature of a hoistway in a vicinity of the desired position of the elevator door component within an image, and
the processor is configured to use information regarding the detected at least one feature within the image and provided information regarding a relationship between the detected at least one feature and the desired position to determine the desired position.

8. The device of claim 1, wherein the detector is configured to detect at least one target that is placed in a known location relative to the desired position of the elevator door component.

9. The device of claim 1, wherein
the detector is configured to detect at least one marker on the elevator door component,
the processor is configured to determine a current position of the elevator door component relative to the desired position based on information from the detector regarding a position of the at least one marker on the elevator door component,
the processor is configured to determine a change in position of the elevator door component to bring the elevator door component into the desired position, and
the processor is configured to control the indicator to dynamically change the indication based on variations in the determined change in position.

10. The device of claim 1, wherein the at least one indication comprises an audible indication.

11. A method of facilitating installation of at least one elevator door component, the method comprising:
detecting at least one reference feature in a vicinity of a desired position of the elevator door component;
using at least one processor for automatically determining the desired position of the elevator door component relative to the at least one detected feature; and
providing at least one indication corresponding to the desired position of the elevator door component.

12. The method of claim 11, wherein the at least one indication comprises a visual indication.

13. The method of claim 12, using a laser to provide the at least one visual indication as a laser projected image.

14. The method of claim 12, comprising causing the visual indication to appear on a portion of the elevator door component to visually indicate when the elevator door component is in the desired position.

15. The method of claim 12, comprising causing the visual indication to appear on a surface near the desired position of the elevator door component.

16. The method of claim 11, wherein the detecting is performed using a LiDAR detector.

17. The method of claim 11, wherein
the detecting is performed using photogrammetry to detect at least one feature of a hoistway in a vicinity of the desired position of the elevator door component within an image, and
determining the desired position of the elevator door component comprises using information regarding the detected at least one feature within the image and provided information regarding a relationship between the detected at least one feature and the desired position.

18. The method of claim 11, wherein the detecting comprises detecting at least one target that is placed in a known location relative to the desired position of the elevator door component.

19. The method of claim 11, wherein
the detecting comprising detecting at least one marker on the elevator door component, automatically determining the desired position comprises
using the processor to determine a current position of the elevator door component relative to the desired position based on information regarding a position of the at least one marker on the elevator door component and
using the processor to determine a change in position of the elevator door component to bring the elevator door component into the desired position, and
providing the at least one indication comprises dynamically changing the indication based on variations in the determined change in position.

20. The method of claim 11, wherein providing the at least one indication comprises providing an audible indication.
